(19) United States
(12) Patent Application Publication
(10) Pub. No.: US 2023/0075496 A1
(43) Pub. Date: Mar. 9, 2023

(54) ELECTRICAL CONTACT ASSEMBLY

(71) Applicant: Illinois Tool Works Inc., Glenview, IL (US)

(72) Inventors: Umang Shukla, Jenison, MI (US); Vishwatej Mane, Allendale, MI (US); David A. Prymula, Allegan, MI (US); Bradley Hazard, Glenview, IL (US); Kenneth S. Dobson, Northville, MI (US)

(21) Appl. No.: 17/895,654

(22) Filed: Aug. 25, 2022

Related U.S. Application Data
(60) Provisional application No. 63/241,616, filed on Sep. 8, 2021.

(51) Int. Cl. H01M 50/533; H01M 50/528; H01M 50/557

(52) U.S. Cl. CPC H01M 50/533; H01M 50/528; H01M 50/557

(57) ABSTRACT

An electrical contact assembly includes a first component and a second component having a stem with a first end and a second end opposite the first end. A flange extends from the first end and defines an electrical contact surface area. The second end is permanently joined to the first component at a mating surface. The mating surface defines a first surface area at the second end and the electrical surface area is equal to or greater than the first surface area.

### CROSS REFERENCE TO RELATED APPLICATIONS

This application claims priority to and the benefit of U.S. Provisional Patent Application No. 63/241,616, filed in the United States Patent and Trademark Office on Sep. 8, 2021, the entire contents of which are incorporated herein by reference as if fully set forth below in their entireties and for all applicable purposes.

### BACKGROUND

### Field of the Disclosure

The present invention relates to an electrical contact. More specifically, a two-piece electrical contact is shown and described herein.

### Description of the Background of the Disclosure

In the field of electrical power circuits, a battery or capacitor is often contained within an enclosure of a machine, device, or assembly for providing electrical power to an electrically-driven component, e.g., a motor. Typically, the enclosure is hermetically or semi-hermetically sealed to prevent ingress or egress of contaminants, as well as to prevent failure. To transfer the electrical power from the battery or capacitor within the enclosure to the electrical component outside of the enclosure, a terminal is mounted to the enclosure and pressed against either a positively charged end or a negatively charged end of the battery or capacitor.

### SUMMARY

In one aspect, an electrical contact assembly includes a first component and a second component having a stem with a first end and a second end opposite the first end. A flange extends from the first end and defines an electrical contact surface area. The second end is permanently joined to the first component at a mating surface. The mating surface defines a first surface area at the second end and the electrical surface area is equal to or greater than the first surface area.

In another aspect, an electrical contact assembly includes a first component having a first surface area and a second component having a second surface area. The second component is configured to be permanently coupled to the first component and includes a third surface area and a fourth surface area. The third surface area may be less than or greater than the second surface area. The sum of the third surface area and the fourth surface area can be greater than or equal to the second surface area. Further, the second, third, and fourth surface areas are spaced apart from each other.

In still another aspect, a two-piece electrical contact assembly includes at least two electrical pathways. A first pathway extends from a first contact area that is disposed concentrically about and spaced apart from a second contact area. The second pathway extends from the second contact area, and the first and second pathways converge within the two-piece assembly.

In yet another aspect, an electrical contact assembly includes a first component and a second component that is configured to be coupled to the first component. Electricity is configured to pass through the first component to the second component. Further, the electrical contact assembly is configured to be mounted to an enclosure, and a hermetic seal is formed by the electrical contact assembly.

In another aspect, an electrical contact assembly includes a first component including an upper side wall, and the upper side wall defines a mating cavity. The second component includes a stem with a first end and a second end opposite the first end. A flange extends from the first end and defines an electrical contact surface area. The first end defines a mating surface and is coupled with the mating cavity of the first component.

In still another aspect, an electrical contact assembly includes a first component having a first electrical contact surface and a second component including a stem and a flange. The flange extends radially outward from the stem and the stem defines a second electrical contact surface that includes a plurality of protrusions.

In yet another aspect, an electrical contact assembly includes a first component having a first electrical contact surface. The first component is defined by a first length and a first width, and the first length and the first width are different from each other. A second component includes a stem and a flange extending outward from the stem. The stem defines a second electrical contact surface that includes a plurality of protrusion.

### DESCRIPTION OF THE DRAWINGS

FIG. 1 is an isometric view of a bottom and side of an embodiment of an electrical contact assembly depicted in an exploded, unassembled state;

FIG. 2 is an isometric view of a top and side of the electrical contact assembly of FIG. 1,

FIG. 3 is a side elevational view of the electrical contact assembly of FIG. 1, being depicted in an assembled state;

FIG. 4 is a bottom plan view of the electrical contact assembly of FIG. 1, being depicted in an assembled state;

FIG. 5 is a sectional view of the electrical contact of FIG. 4 taken along section line A-A;

FIG. 6 is an isometric view of a bottom and side of another embodiment of an electrical contact assembly depicted in an exploded, unassembled state;

FIG. 7 is an isometric view of a top and side of the electrical contact assembly of FIG. 6;

FIG. 8 is a side elevational view of the electrical contact assembly of FIG. 6;

FIG. 9 is a bottom plan view of the electrical contact assembly of FIG. 6, being depicted in an assembled state;

FIG. 10 is a sectional view of the electrical contact of FIG. 9 taken along section line B-B;

FIG. 11 is an isometric view of a bottom and side of yet another embodiment of an electrical contact assembly depicted in an exploded, unassembled state;

FIG. 12 is an isometric view of a top and side of the electrical contact assembly of FIG. 11;

FIG. 13 is a side elevational view of the electrical contact assembly of FIG. 11, being depicted in an assembled state;

FIG. 14 is a bottom plan view of the electrical contact assembly of FIG. 11, being depicted in an assembled state;

FIG. 15 is a sectional view of the electrical contact of FIG. 4 taken along section line C-C;

FIG. 16 is a sectional view of another embodiment of an electrical contact assembly; and

FIG. 17 is a sectional view of yet another embodiment of an electrical contact assembly.

### DETAILED DESCRIPTION

The term “about,” as used herein, refers to variations in the numerical quantity that may occur, for example, through typical measuring and manufacturing procedures used for articles of manufacture that may include embodiments of the disclosure herein; through inadvertent error in these procedures; through differences in the manufacture, source, or purity of the ingredients used to make the component or carry out any of the methods; and the like. Throughout the disclosure, the terms “about” and “approximately” refer to a range of values±5% of the numeric value that the term precedes.

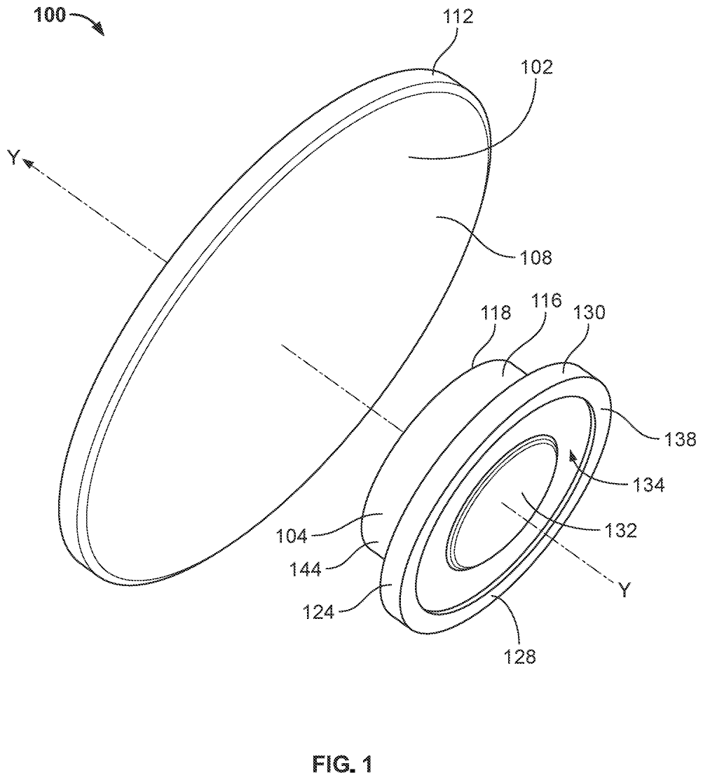

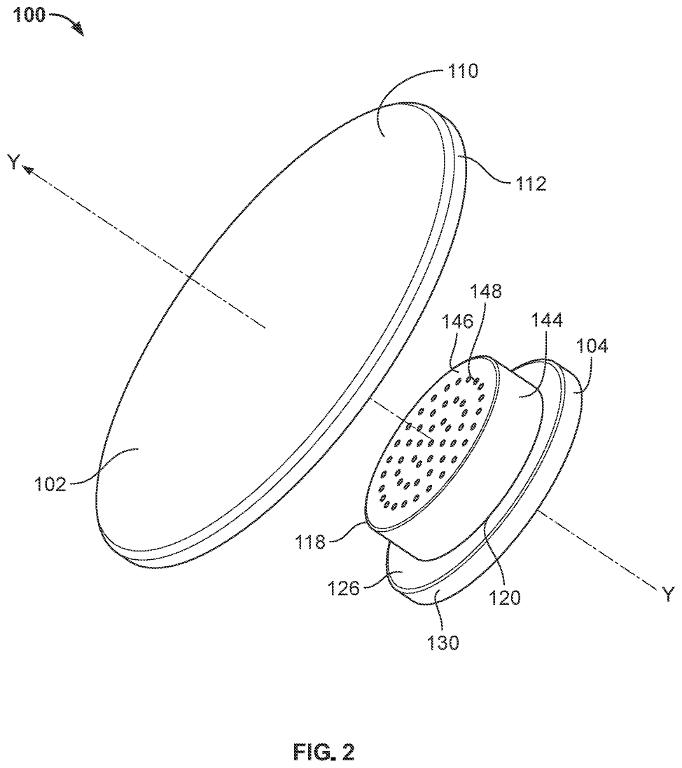

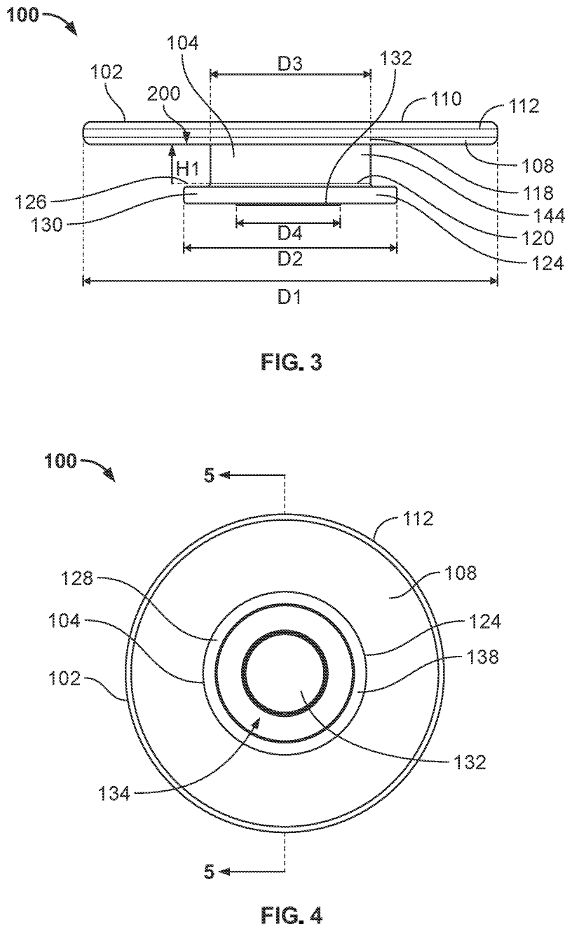

FIGS. 1 and 2 are exploded isometric views of an electrical contact assembly 100, including a first component 102 and second component 104, both of which are comprised of an electrically conductive material. The first component 102 includes a bottom surface 108 and an upper surface 110 opposite the bottom surface 108. The bottom surface 108 at least partially defines a mating surface thereon. An edge 112 extends between the bottom surface 108 and the upper surface 110 and further defines a perimeter of the first component 102. In the illustrated embodiment, the first component 102 is a disc-shaped part having a first dimension, e.g., a first diameter D (see FIG. 3). For illustrative purposes, a central axis Y is centrally disposed through the electrical contact assembly 100 and, thus, passes through a center of the first component 102.

Referring to FIGS. 1 and 2, the second component 104 includes a stem 116 through which the central axis Y is disposed centrally therethrough. In the illustrated embodiment, the stem 116 has a first end 118 and a second end 120 opposite the first end 118, and a flange 124 extends radially outwardly about the second end 120. As best seen in FIG. 2, the flange 124 includes a top surface 126 that extends at least partially about the stem 116. The top surface 126 is opposite a bottom surface 128 of the flange 124 and a flange edge 130 extends between the top surface 126 and the bottom surface 128. The flange edge 130 defines a periphery of the flange 124.

As best seen in FIG. 1, the bottom surface 128 of the flange 124 includes a central portion 132, a channel 134, and a rim 138 therealong. The central portion 132 is disposed centrally on the bottom surface 128 so as to be intersected by central axis Y. The channel 134 extends radially about the central axis Y and is at least partially circumjacent the central portion 132. Further, the rim 138 extends radially about the central axis Y and is at least partially circumjacent the central portion 132 and the channel 134. In the illustrated embodiment, the channel 134 is disposed between the central portion 132 and the rim 138.

Still referring to FIGS. 1 and 2, the stem 116 also includes a sidewall 144 extending between the first end 118 and the second end 120. As best seen in FIG. 2, a mating surface 146 is disposed at the first end 118. The mating surface 146 is configured to be coupled with the bottom surface 108 of the first component 102 and, in particular, with the mating portion of the bottom surface 108. In the illustrated embodiment, the first component 102 and the second component 104 are axially aligned along the central axis Y, the mating surface 146 of the second component 104 is configured to face the bottom surface 108 of the first component 102, and then the mating surface 146 is brought into contact with the bottom surface 108 of the first component 102, resulting in the assembled state of FIG. 3.

Referring to FIG. 2, the mating surface 146 of the second component 104 may be coupled to the bottom surface 108 of the first component by ultrasonic welding and, as such, a plurality of protrusions 148 (e.g., nubs, dots, spikes, ribs, rings, or the like) can be provided along the mating surface 146 to facilitate joining of the first and second components 102, 104 through the welding process. In this way, the electrical contact assembly 100 may be joined by a process that minimizes the creation of debris and also reduces or avoids the use of lubricants. In some embodiments, the plurality of protrusions 148 may comprise a particular quantity of protrusions having a unit density, such as, e.g., about one protrusion per square millimeter, about four protrusions per square millimeter, or about nine protrusions per square millimeter, among other configurations. However, it is contemplated that other methods of joining first and second components 102, 104 can be used, such as, e.g., by fastening, adhering, interlocking geometries, molding, another type of welding, or any other suitable method. It is further contemplated that the first and second components 102, 104 may be permanently fastened or joined, such as by ultrasonic welding, although in some embodiments temporary methods of joining or fastening may be used so as to allow the first and second components 102, 104 to be removably joined or fastened.

Because of the generally cylindrical shape of the electrical contact assembly 100, the side view of FIG. 3 is representative of a front, rear, right, and left side elevational view of the electrical contact assembly 100. As illustrated in FIG. 3, when the first component 102 and the second component 104 are illustrated in the assembled state, the flange 124 of the second component 104 is spaced apart from the first component 102. In particular, the top surface 126 of the flange 124 is spaced apart from the bottom surface 108 of the first component 102 a height H, which is approximately equal to a distance between the top surface 126 and the first end 118 of the second component 104. As mentioned above, the first component 102 defines a first dimension, e.g., the first diameter D1, that is bounded by the edge 112. The second component 104 defines a second dimension, e.g., a second diameter D2, that is bounded by the flange edge 130, a third dimension, e.g., a third diameter D3, that is bounded by the sidewall 144 of the stem 116, and a fourth dimension, e.g., a fourth diameter D4, that is bounded by a perimeter edge of the central portion 132. As can be appreciated from the illustrated embodiment, the first diameter D1 is greater than the second diameter D2, the second diameter D2 is greater than the third diameter D3, and the third diameter D3 is greater than the fourth diameter D4. It is contemplated that the third diameter D3 can be greater than the second diameter D2, among other configurations.

The electrical contact assembly 100 is configured to be mounted to an enclosure (not shown) in which a battery (not shown) is contained, typically being hermetically sealed therein to prevent ingress and egress relative to the enclosure. As such, a mounting space 170 is formed between the first and second components 102, 104 and, more specifically, the mounting space 170 is bounded by the top surface 126 of the flange 124, the bottom surface 108 of the first component 102, and the sidewall 144 of the stem 116. In addition, the mounting space 170 extends radially outwardly from the sidewall 144 of the stem 116 to, at least, the flange edge 130. As such, the mounting space 170 is an annular-shaped volume which may be understood as having a height equal to H1, an outer diameter equal to the second diameter D2, and a thickness equal to the second diameter D2 subtracted by the third diameter D3. When the assembly is mounted to the enclosure, the mounting space 170 is configured to receive a portion of the enclosure and, in some examples, an isolating gasket (not shown). The isolating gasket is configured to electrically isolate the electrical contact assembly 100 from the enclosure by preventing direct contact and/or conducting electricity therebetween and, thus, the isolating gasket may be comprised of a non-conductive material, such as, e.g., ceramic, rubber, or any other suitable material. Further, the isolating gasket may be configured to absorb vibrations, to prevent heat transfer, to prevent dislodgement of the electrical contact assembly 100 from the enclosure, and to prevent ingress and egress relative to the enclosure, e.g., by way of a hermetic or semi-hermetic seal. In this way, the electrical contact assembly 100 includes the joining of the first component 102 to the second component 104 such that a third component, i.e., the isolating gasket (not shown), is compressed to prevent direct contact with a fourth component, i.e., the enclosure (not shown). It is contemplated that an amount of protection against ingress and egress provided by the electrical contact assembly 100 may vary, depending upon the inclusion and type of isolation gasket (not shown), among other factors.

During use as an electrical contact assembly 100, the bottom surface 128 of the flange 124 is configured to be contacted by an electrical component (e.g., a battery). As such, the bottom surface 128 (as best seen in FIG. 4) defines an electrical contact surface area through which electrical current may pass. Because the battery will often have a planar surface presented to contact the electrical contact surface area of the bottom surface 128 of the flange 124, the electrical contact surface is co-planar and includes the entire surface area of the bottom surface 128 subtracted by the area of the channel 134, such that the electrical contact surface area is a portion of the bottom surface 128. Differently said, the channel 134 is configured to reduce the co-planar surface area of the bottom surface 128 to form the electrical contact surface area through which electrical current flows from the battery to the second component 104.

For example, the total surface area of the bottom surface 128 is defined by the well-known formula for calculating the area of a circle in which a radius equal to half of the second diameter D′ is an input. To obtain the electrical contact surface area, an annular area of the channel 134 may be subtracted from the total surface area of the bottom surface 128 of the flange 124. Differently said, the electrical contact surface area is equal to the sum of the surface area of the central portion 232 and the surface area of the rim 238. Accordingly, the electrical contact surface area may be less than the total surface area of the bottom surface 128 of the flange 124. In the illustrated embodiment, the central portion 132, the channel 134, and the rim 138 of the flange are each sized and shaped to define the electrical contact surface area.

Further, it will be appreciated that the mating surface 146 defines a mating surface area calculated by the well-known formula for calculating the area of a circle in which a radius equal to half of the third diameter D″ is an input. In accordance with the well-known principles of conductance and resistivity, the mating surface area relates to the electrical contact surface area. In some embodiments, the mating surface area is equal to the electrical contact surface area. In other embodiments, the electrical contact surface area is greater than the mating surface area of the mating surface 146. In the illustrated embodiment, the fourth diameter D4 of the central portion 132 may not be greater than the third diameter D3 of the stem 116. As a result of providing the channel 134 along the bottom surface 128, the flange 124 may define a greater diameter (i.e., D2) than the diameter of the stem 116 (i.e., D3) and, thus, the mounting space 170 can be formed to receive a portion of the enclosure for facilitating assembly with the enclosure. Optionally, the bottom surface 128 of the flange 124 may comprise different geometries and surfaces that can be combined to define the electrical contract surface area.

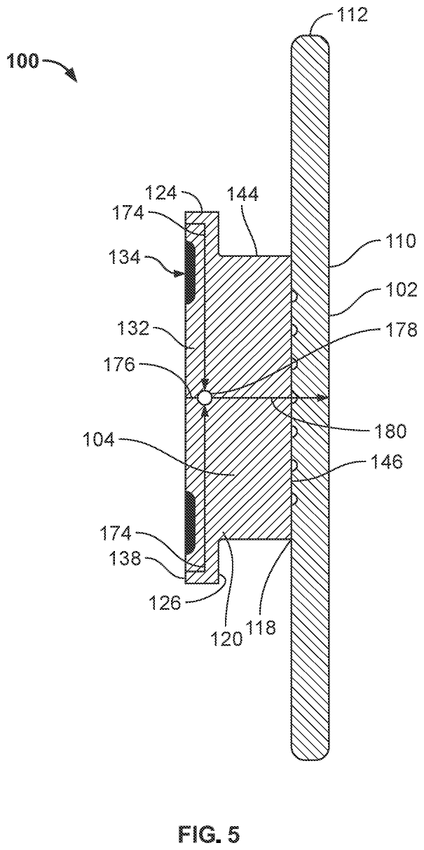

With continued reference to FIG. 5, the second component 104 is configured to provide multiple electrical pathways for conducting electricity through to the first component 102. In the illustrated embodiment, an outer electrical pathway 174 may extend from the rim 138, i.e., a first contact surface, toward the stem 116. Also, an inner electrical pathway extends from the central portion 132, i.e., a second contact surface, toward the stem 116, with the central portion 132 being disposed concentrically with the rim 138, as best seen in FIG. 4. Accordingly, electricity conducted from the outer electrical pathway 174 and the inner electrical pathway 176 converge and/or combine within the electrical contact assembly 100 at the stem 116 and, in particular, at a node 178 of the stem 116. From the node 178, the electricity then travels in a third electrical pathway 180 through the mating surface 146 to the first component 102. In this way, electricity is conducted through the electrical contact assembly 100 according to multiple pathways. It is contemplated that greater or fewer electrical pathways may be provided, or that different materials may be provided to direct or control the flow of electricity through the electrical contact assembly 100. It is further contemplated that in some applications, the inner electrical pathway 176 may be a primary pathway and the outer electrical pathway 174 may be a secondary pathway.

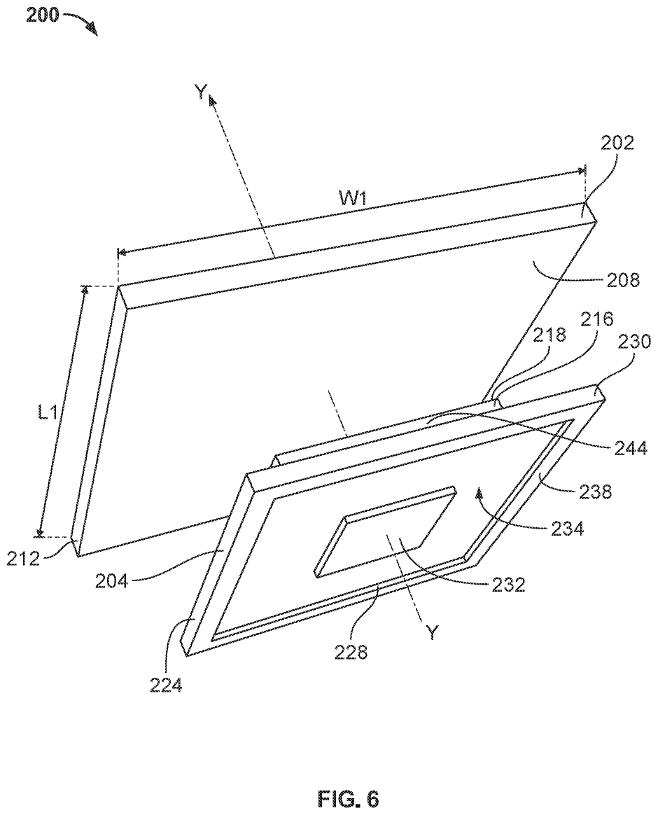

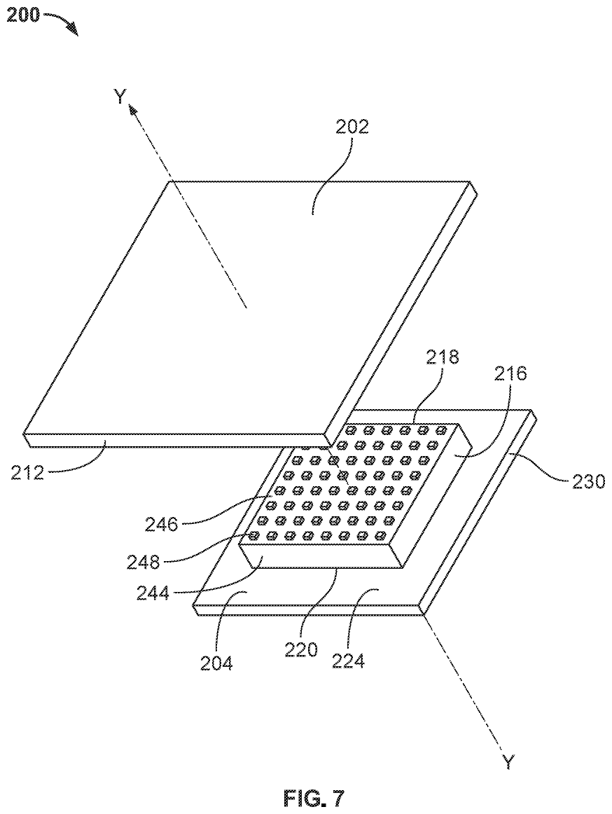

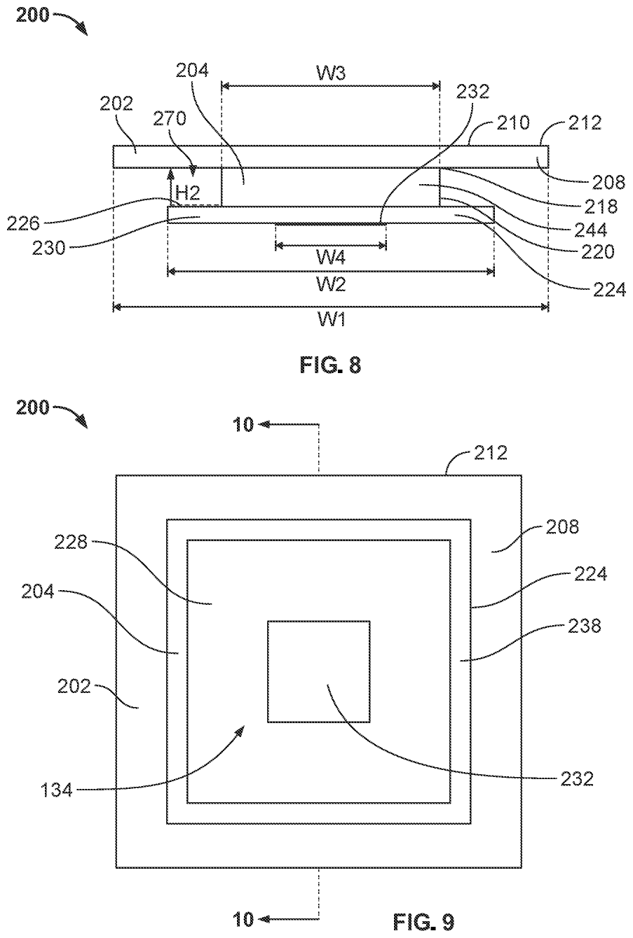

FIGS. 6 and 7 are exploded isometric views of another embodiment of an electrical contact assembly 200, including a first component 202 and second component 204, both of which are comprised of an electrically conductive material. The first component 202 includes a bottom surface 208 and an upper surface 210 opposite the bottom surface 208. The bottom surface 208 at least partially defines a mating surface thereon. An edge 212 extends between the bottom surface 208 and the upper surface 210 and further defines a perimeter of the first component 202. In the illustrated embodiment, the first component 202 is a generally square-shaped part having a first dimension, e.g., a first width W1 (see FIG. 8), that is bounded by the edge 212. Because the first component 202 is generally square-shaped, the first dimension may be measured between the opposing sides of the edge 212, e.g., in front-to-rear or right-to-left directions, such that a first length L1 is substantially equivalent to the first width W1. Thus, the first dimension is inclusive of the first width W1 and the first length L1 of the electrical contact assembly 200. However, it is contemplated that the first component 202 may be generally rectangular-shaped, triangular-shaped, or irregularly-shaped and, thus, the first length L1 and the first width W1 may not be equal. For illustrative purposes, the central axis Y is shown centrally disposed through the electrical contact assembly 200 and, thus, passes through a center of the first component 202.

Referring to FIGS. 6 and 7, the second component 204 includes a stem 216 through which the central axis Y is disposed centrally therethrough. In the illustrated embodiment, the stem 216 has a first end 218 and a second end 220 opposite the first end 218, and a flange 224 extends outwardly from the second end 220. As best seen in FIG. 2, the flange 224 includes a top surface 226 that extends at least partially about the stem 216. The top surface 226 is opposite a bottom surface 228 of the flange 224 and a flange edge 230 extends between the top surface 226 and the bottom surface 228. The flange edge 230 defines a periphery of the flange 224.

As best seen in FIG. 6, the bottom surface 228 of the flange 224 includes a central portion 232, a channel 234, and a rim 238 therealong. The central portion 232 is disposed centrally on the bottom surface 228 so as to be intersected by the central axis Y. The channel 234 extends about the central axis Y and at least partially surrounds the central portion 232. Further, the rim 238 extends about the central axis Y and at least partially surrounds the central portion 232 and the channel 234. In the illustrated embodiment, the channel 234 is disposed closer to the central portion 232 than the rim 238.

Still referring to FIGS. 6 and 7, the stem 216 also includes a sidewall 244 extending between the first end 218 and the second end 220. As best seen in FIG. 7, a mating surface 246 is disposed at the first end 218. The mating surface 246 is configured to be coupled with the bottom surface 208 of the first component 202 and, in particular, with the mating portion of the bottom surface 208. In the illustrated embodiment, the first component 202 and the second component 204 are axially aligned along the central axis Y, the mating surface 246 of the second component 204 is configured to face the bottom surface 208 of the first component 202, and then the mating surface 246 is brought into contact with the bottom surface 208 of the first component 202, resulting in the assembled state of FIG. 8.

Referring to FIG. 7 the mating surface 246 of the second component 204 may be coupled to the bottom surface 208 of the first component by ultrasonic welding and, as such, a plurality of protrusions 248 (e.g., nubs, dots, spikes, ribs, rings, or the like) can be provided along the mating surface 246 to facilitate joining of the first and second components 202, 204 through the welding process. In this way, the electrical contact assembly 100 may be joined by a process that minimizes the creation of debris and also reduces or avoids the use of lubricants. In some embodiments, the plurality of protrusions 248 may comprise a particular quantity of protrusions having a unit density, such as, e.g., about one protrusion per square millimeter, about four protrusions per square millimeter, or about nine protrusions per square millimeter, among other configurations. However, it is contemplated that other methods of joining first and second components 202, 204 can be used, such as, e.g., by fastening, adhering, interlocking geometries, molding, another type of welding, or any other suitable method. It is further contemplated that the first and second components 202, 204 may be permanently fastened or joined, such as by ultrasonic welding, although in some embodiments temporary methods of joining or fastening may be used so as to allow the first and second components 202, 204 to be removably joined or fastened.

Referring to the side elevational view of FIG. 8, when the first component 202 and the second component 204 are illustrated in the assembled state, the flange 224 of the second component 204 is spaced apart from the first component 202. In particular, the top surface 226 of the flange 224 is spaced apart from the bottom surface 208 of the first component 202 a height H′, which is approximately equal to a distance between the top surface 226 and the first end 218 of the second component 204. As mentioned above, the first component 202 defines the first width W1 and the first length L1 bounded by the edge 212. Referring to FIG. 8, the second component 204 defines a second width W2 bounded by the flange edge 230, a third width W3 bounded by the sidewall 244 of the stem 216, and a fourth width W4 bounded by a perimeter edge of the central portion 232. As can be appreciated from the illustrated embodiment, the first width W1 is greater than the second width W2, the second width W2 is greater than the third width W3, and the third width W3 is greater than the fourth width W4. Because of the generally square shape of the electrical contact assembly 200, the side view of FIG. 8 is representative of a front, rear, right, and left side elevational view of the electrical contact assembly 200. Accordingly, it will be appreciated that the first length L1 is substantially equivalent to first width W1, and that a second length L2 is substantially equivalent to the second width W2, a third length L3 is substantially equivalent to the third width W3, and a fourth length L4 is substantially equivalent to the fourth width W4.

Similar to the electrical contact assembly 100, the electrical contact assembly 200 is configured to be mounted to an enclosure (not shown) in which a battery (not shown) is contained, typically being hermetically sealed therein. As such, a mounting space 270 is formed between the first and second components 202, 204 and, more specifically, the mounting space 270 is bounded by the top surface 226 of the flange 224, the bottom surface 208 of the first component 202, and the sidewall 244 of the stem 216. In addition, the mounting space 270 extends outwardly from the sidewall 244 of the stem 216 to, at least, the flange edge 230. As such, the mounting space 270 is a square annulus which may be understood as having a height equal to H2, an outer width equal to the second width W2, and a thickness equal to the second diameter W2 subtracted by the third width W3. When the electrical contact assembly 200 is mounted to the enclosure, the mounting space 270 is configured to receive a portion of the enclosure and, in some examples, an isolating gasket (not shown), as described above.

In some applications, the bottom surface 228 of the flange 224 is configured to be contacted by an electrical component (e.g., a battery). As such, the bottom surface 228 defines an electrical contact surface area through which electrical current may pass. Because the battery will often have a planar surface presented to contact the electrical contact surface area of the bottom surface 228 of the flange 224, the electrical contact surface is co-planar and includes the entire surface area of the bottom surface 228 subtracted by the area of the channel 234, such that the electrical contact surface area is a portion of the bottom surface 228. Differently said, the channel 234 is configured to reduce the co-planar surface area of the bottom surface 228 to form the electrical contact surface area through which electrical current flows from the battery to the second component 204. In particular, electrical contact surface area is the sum of the surface area of the central portion 232 and the surface area of the rim 238.

For example, the total surface area of the bottom surface 228 is defined by the well-known formula for calculating the area of a rectangle in which a length dimension, e.g., the second length L2, and a width dimension, e.g., the second width W2 are inputs. To obtain the electrical contact surface area, an area of the channel 234 may be subtracted from the total surface area of the bottom surface 228 of the flange 224. Accordingly, the electrical contact surface area may be less than the total surface area of the bottom surface 228 of the flange 224.

Further, it will be appreciated that the mating surface 246 defines a mating surface area calculated by the well-known formula for calculating the area of a rectangle in which a width dimension, e.g., the third width W3, and a length dimension, e.g., the third length L3, are inputs. In accordance with the well-known principles of conductance and resistivity, the mating surface area relates to the electrical contact surface area. As a result, the central portion 232, the channel 234, and the rim 238 of the flange are each sized and shaped to define the electrical contact surface to be equal to or exceed the mating surface area of the mating surface 246. Further, the fourth dimension, e.g., the fourth length L4 and/or width W4, of the central portion 232 may not be greater than the third dimension, e.g., the third length L3 and/or width W3, of the stem 216. As a result of providing the channel 234 along the bottom surface 228, the flange 224 may extend outwardly from the stem 216 and, thus, the mounting space 270 can be formed to receive a portion of the enclosure for facilitating assembly with the enclosure.

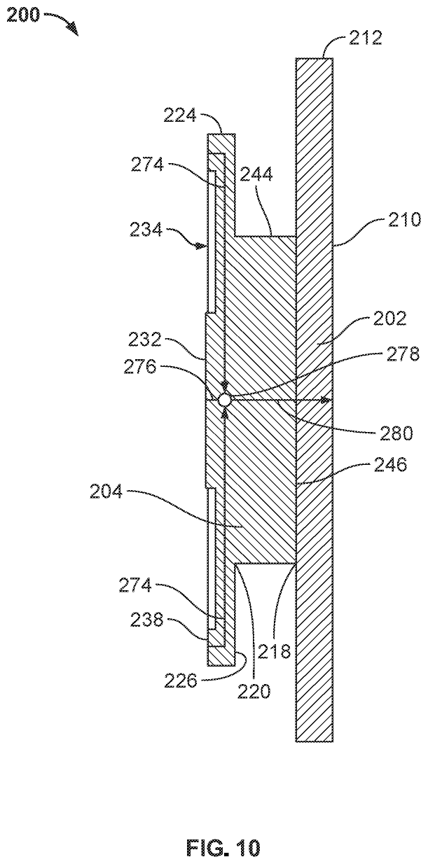

With continued reference to FIG. 10, the second component 204 is configured to provide multiple electrical pathways for conducting electricity through to the first component 202. In the illustrated embodiment, an outer electrical pathway 274 may extend from the rim 238, i.e., a first contact surface, toward the stem 216. Also, an inner electrical pathway 276 extends from the central portion 232, i.e., a second contact surface, toward the stem 216, with the central portion 232 being disposed concentrically with the rim 238, as best seen in FIG. 9. Accordingly, electricity conducted from the outer electrical pathway 274 and the inner electrical pathway 276 converge and/or combine within the electrical contact assembly 200 at the stem 216 and, in particular, at a node 278 of the stem 216. From the node 278, the electricity then travels in a third electrical pathway 280 through the mating surface 246 to the first component 202. Thus, electricity is conducted within and through the electrical contact assembly 200 according to multiple pathways extending from multiple contact surfaces. It is contemplated that greater or fewer electrical pathways may be provided, or that different materials may be provided to direct or control the flow of electricity through the electrical contact assembly 200. It is further contemplated that in some applications, the inner electrical pathway 276 may be a primary pathway and the outer electrical pathway 274 may be a secondary pathway.

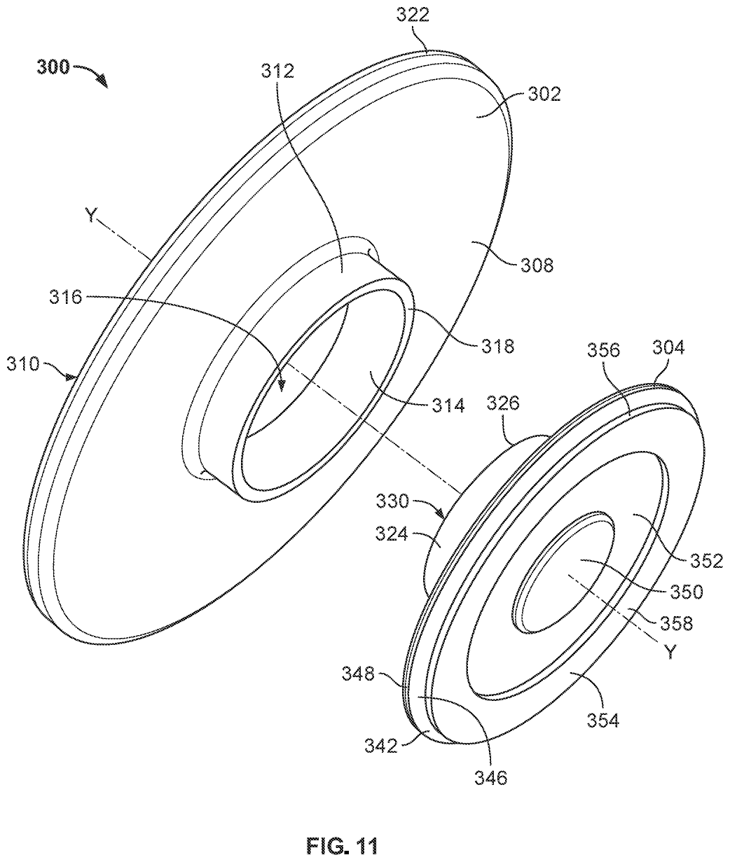

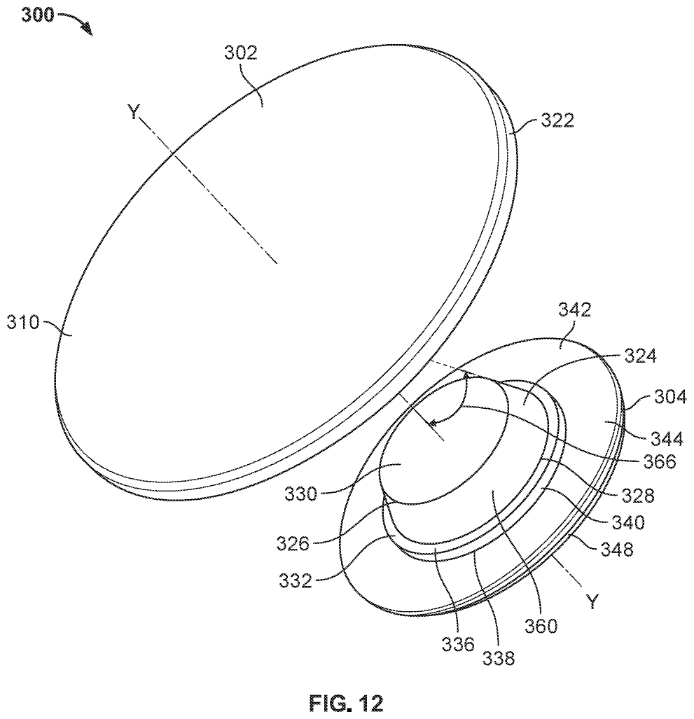

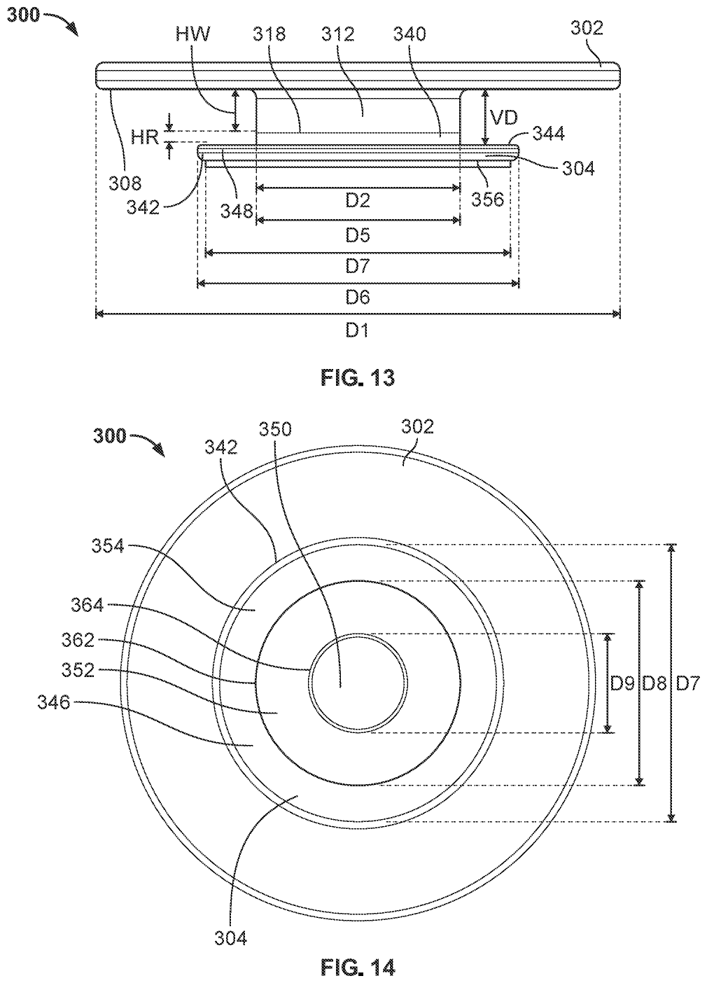

FIGS. 11 and 12 are exploded isometric views of an electrical contact assembly 300, including a first component 302 and second component 304, both of which are comprised of an electrically conductive material. The first component 302 includes a bottom surface 308 and an upper surface 310 opposite the bottom surface 308. The bottom surface 308 includes an upper side wall 312 extending away from the bottom surface 308 as an annular projection. The upper side wall 312 includes an inner side wall 314 that defines a tapered hole 316. A contact edge or contact surface 318 is defined by the upper side wall 312 opposite the bottom surface 308 and the inner side wall 314 extends at an angle between the bottom surface 308 and the contact edge 318. It will be appreciated that the tapered hole 316 may be referred to herein as the mating cavity. An edge 322 extends between the bottom surface 308 and the upper surface 310 and further defines a perimeter of the first component 302. In the illustrated embodiment, the first component 302 is a disc-shaped part having a first dimension, e.g., a first diameter D1 (see FIG. 13). For illustrative purposes, a central axis Y is centrally disposed through the electrical contact assembly 300 and, thus, passes through a center of the first component 302 and the second component 304.

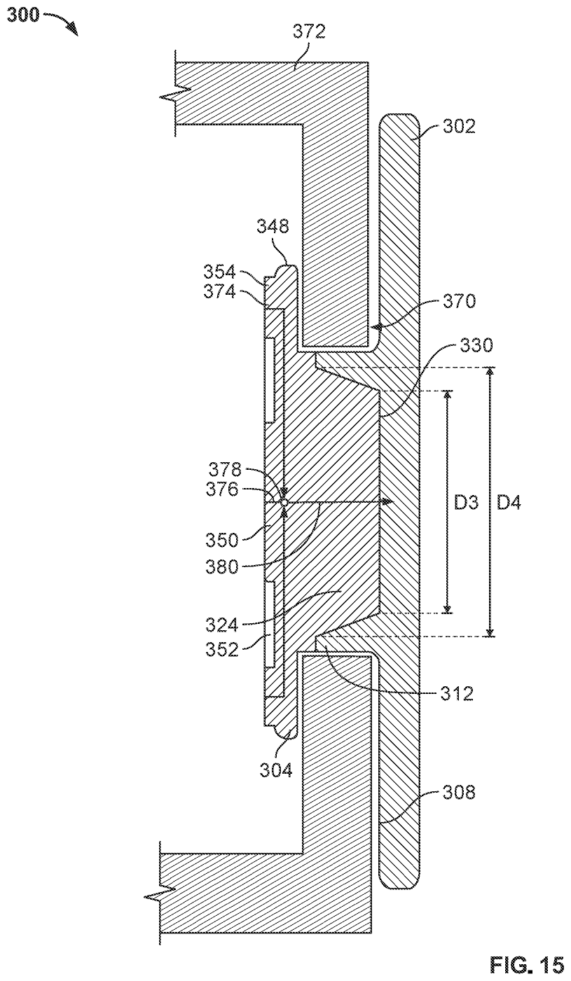

Referring to FIGS. 11 and 12, the second component 304 includes a tapered stem 324 through which the central axis Y is disposed centrally therethrough. In the illustrated embodiment, the tapered stem 324 has a first end 326 and a second end 328 opposite the first end 326. The first end 326 has a diameter is smaller than a diameter of the second end 328 (see D3 and D4 of FIG. 15). The first end 326 defines a mating surface 330 that is configured to be received within the tapered hole 316 and to abut the bottom surface 308 of the first component 302, when assembled.

As illustrated in FIG. 12, an upper rim 332 extends circumferentially about the second end 328 of the tapered stem 324. The upper rim 332 includes an upper rim surface 336 and an interface or third end 338 opposite the upper rim surface 336. An upper rim edge 340 extends between the upper rim surface 336 and the third end 338. A flange 342 extends circumferentially about the third end 338 of the upper rim 332. As shown in FIG. 12, the flange 342 includes a top surface 344 that is opposite a bottom surface 346, and a flange edge 348 extends between the top surface 344 and the bottom surface 346. In the illustrated embodiment, the top surface 344 extends radially outwardly and planar from the upper rim 332 to the flange edge 348. The flange edge 348 defines an outer periphery of the flange 342.

As best seen in FIG. 11, the bottom surface 346 of the flange 342 includes a central raised portion 350, a channel 352, and a raised rim 354. The central raised portion 350 is disposed centrally on the bottom surface 346 so as to be intersected by central axis Y. The channel 352 extends radially about the central axis Y and is at least partially circumjacent the central portion 350. Further, the raised rim 354 extends radially about the central axis Y and is at least partially circumjacent the central raised portion 350 and the channel 352. In the illustrated embodiment, the channel 352 is disposed between the central raised portion 350 and the raised rim 354. The raised rim 354 includes a raised rim edge 356 disposed between the bottom surface 346 and a flat surface 358 of the raised rim 354.

Still referring to FIGS. 11 and 12, the tapered stem 324 also includes a sidewall 360 extending between the first end 326 and the second end 328. As best seen in FIG. 12, the mating surface 330 is disposed at the first end 118. The mating surface 330 is configured to be coupled with the bottom surface 308 of the first component 302 and, in particular, within the tapered hole 316 defined within the upper side wall 312 of the bottom surface 308. For example, a method of assembling the first component 302 and second component 304 includes axially aligning the first component 302 and the second component 304 along the central axis Y, inserting the mating surface 330 of the second component 304 within the tapered hole 316 of the first component 302, and bringing the contact surface 318 into contact with the upper rim surface 336, resulting in the assembled state of FIG. 13. Accordingly, the tapered stem 324 and the inner side wall 314 of the upper side wall 312 are formed with the corresponding draft angle 366 to provide a flush fit within the tapered hole 316, such that the tapered stem 324 and upper side wall 312 maintain concentricity between the first component 302 and the second component 304, when assembled. Further, the contact surface 318 of the upper side wall 312 and the upper rim surface 336 of the rim 332 are configured to abut one another to provide flush contact, which is configured to concentrically locate the first and second component 302, 304 relative to one another about the axis Y. In this way, the first component 302 and the second component 304 are configured to be concentrically fit to one another about the axis Y.

In some embodiments, the fit between the tapered hole 316 of the first component 302 and the tapered stem 324 of the second component 304 may be a hermetic fitting or a semi-hermetic fitting. For example, the hermetic fitting may be applied between the mating surface 330 of the second component 304 and the bottom surface 308 of the first component 302 by ultrasonic welding. In this way, the electrical contact assembly 300 may be joined by a process that minimizes the creation of debris and also reduces or avoids the use of lubricants. However, it is contemplated that other methods of joining first and second components 302, 304 can be used, such as, e.g., by fastening, adhering, interlocking geometries, molding, another type of welding, or any other suitable method. It is further contemplated that the first and second components 302, 304 may be permanently fastened or joined, such as by ultrasonic welding, although in some embodiments temporary methods of joining or fastening may be used so as to allow the first and second components 302, 304 to be removably joined or fastened.

Because of the generally cylindrical shape of the electrical contact assembly 300, the side view of FIG. 13 is representative of a front, rear, right, and left side elevational view of the electrical contact assembly 300. As illustrated in FIG. 13, when the first component 302 and the second component 304 are illustrated in the assembled state, the top surface 344 of the flange 342 of the second component 304 is spaced apart from the bottom surface 308 of the first component 302. The upper side wall 312 defines a wall height HW, which is measured between the contact edge 318 and the bottom surface 308 of the first component 302. The tapered stem 324 defines a stem height HS (see FIG. 15), which is measured between the first end 326 and the second end 328 of the second component 304. In the illustrated embodiment, the stem height HS is equal to the wall height HW. The upper rim edge 340 defines a rim height HR measured, which is measured between the upper rim surface 336 and the top surface 344 of the second component 304. As illustrated in FIG. 13, a vertical distance VD between the top surface 344 of the flange 342 of the second component 304 and the bottom surface 308 of the first component 302 is equal to the sum of the rim height HR and the wall height HW.

As mentioned above, the first component 302 defines a first dimension, e.g., the first diameter D1, that is bounded by the edge 322. A second dimension, e.g., the second diameter D2, defined by the outer diameter of the upper side wall 312 bounded by the contact edge 318. The second component 304 defines a third dimension, e.g., a third diameter D3 (see FIG. 15), that is bounded by the first end 326 of the tapered stem 324, a fourth dimension, e.g., a fourth diameter D4 (see FIG. 15), that is bounded by the second end 328 of the tapered stem 324, a fifth dimension, e.g., a fifth diameter D5, that is bounded by third end 338 of the upper rim 332, and equal to the second diameter, a sixth dimension, e.g., a sixth diameter D6, that is bounded by the flange end 348, a seventh dimension, e.g., a seventh diameter D7, that is bounded by the raised rim edge 356, an eighth dimension, e.g., an eighth diameter D8 (see FIG. 14), that is bounded by an outer periphery 362 of the channel 352, and an ninth dimension, e.g., a ninth diameter D9 (see FIG. 14), that is bounded by an outer perimeter 364 central portion 350.

Referring back to FIG. 12, the tapered stem 324 narrows from the second end 328 to the first end 326 to define a draft angle 366 relative to the axis Y. The draft angle 366 can be determined by taking the inverse tangent of a value obtained by subtracting the third diameter D3 from the fourth diameter D4, and then dividing the value by twice the length of the stem height HS. The draft angle 366 of the present disclosure may be an acute angle. The draft angle 366 may be about 5 degrees, or about 10 degrees, or about 15 degrees, or about 20 degrees, or about 25 degrees, or about 30 degrees, or about 35 degrees, or about 40 degrees, or about 45 degrees or about 50 degrees, or about 60 degrees, or about 70 degrees, or even about 80 degrees. It will be appreciated that the inner side wall 314 is formed to correspond with the draft angle 366, such that the inner side wall 314 extends from the bottom surface 308 to the contact surface 318 at an angle equal to the draft angle 366 about the central axis Y.

During use as an electrical contact assembly 300, the bottom surface 346 of the flange 342 is configured to be contacted by an electrical component (e.g., a battery). Referring to FIG. 14, the bottom surface 346 defines an electrical contact surface area through which electrical current may pass. Because the battery will often have a planar surface presented to contact the electrical contact surface area of the bottom surface 346 of the flange 342, the electrical contact surface is co-planar and includes the entire surface area of the bottom surface 346 subtracted by the area of the channel 352, such that the electrical contact surface area is a portion of the bottom surface 346. Differently said, the channel 352 is configured to reduce the co-planar surface area of the bottom surface 346 to form the electrical contact surface area through which electrical current flows from the battery to the second component 304.

For example, the total surface area of the bottom surface 346 is defined by the well-known formula for calculating the area of a circle in which a radius is equal to half of the diameter. To obtain the electrical contact surface area, an annular area of the channel 352 may be subtracted from the total surface area of the bottom surface 346 of the flange 342. Differently said, the electrical contact surface area is equal to the sum of the surface area of the central portion 350 and the surface area of the raised rim 354. Accordingly, the electrical contact surface area may be less than the total surface area of the bottom surface 346 of the flange 342. In the illustrated embodiment, the central portion 350, the channel 352, and the raised rim 354 of the flange 342 are each sized and shaped to define the electrical contact surface area.

Further, it will be appreciated that the mating surface 330 defines a mating surface area calculated by the well-known formula for calculating the area of a circle in which a radius equal to half of the third diameter D3 is an input. In accordance with the well-known principles of conductance and resistivity, the mating surface area relates to the electrical contact surface area. In some embodiments, the mating surface area is equal to the electrical contact surface area. In other embodiments, the electrical contact surface area is greater than the mating surface area of the mating surface 330. In the illustrated embodiment, the ninth diameter D9 of the central portion 350 may not be greater than the fourth diameter D4 of the tapered stem 324. As a result of providing the channel 352 along the bottom surface 346, the flange 342 may define a greater diameter (i.e., D6) than the diameter of the tapered stem 324 (i.e., D4). Thus, referring to FIG. 13, a mounting space 370 can be formed to receive a portion of the enclosure for facilitating assembly with the enclosure. Optionally, the bottom surface 346 of the flange 342 may comprise different geometries and surfaces that can be combined to define the electrical contract surface area.

Referring now to FIG. 15, the electrical contact assembly 300 is configured to be mounted to an enclosure 372 in which a battery (not shown) is contained, typically being hermetically sealed therein to prevent ingress and egress relative to the enclosure. As such, a mounting space 370 is formed between the first and second components 302, 304 and, more specifically, the mounting space 370 is bounded by the top surface 344 of the flange 342, the bottom surface 308 and the upper side wall 312 of the first component 302. In addition, the mounting space 370 extends radially outwardly from the upper side wall 312 to, at least, the flange edge 348. As such, the mounting space 370 is an annular-shaped volume which may be understood as having a height equal to the vertical distance VD, an outer diameter equal to the sixth diameter D6, and a thickness equal to the sixth diameter D6 subtracted by the second diameter D2. When the assembly is mounted to the enclosure, the mounting space 370 is configured to receive a portion of the enclosure and, in some examples, an isolating gasket (not shown). The isolating gasket is configured to electrically isolate the electrical contact assembly 300 from the enclosure by preventing direct contact and/or conducting electricity therebetween and, thus, the isolating gasket may be comprised of a non-conductive material, such as, e.g., ceramic, rubber, or any other suitable material. Further, the isolating gasket may be configured to absorb vibrations, to prevent heat transfer, to prevent dislodgement of the electrical contact assembly 300 from the enclosure, and to prevent ingress and egress relative to the enclosure, e.g., by way of a hermetic or semi-hermetic seal. In this way, the electrical contact assembly 300 includes the joining of the first component 302 to the second component 304 such that a third component, i.e., the isolating gasket (not shown), is compressed to prevent direct contact with a fourth component, i.e., the enclosure (not shown). It is contemplated that an amount of protection against ingress and egress provided by the electrical contact assembly 300 may vary, depending upon the inclusion and type of isolation gasket (not shown), among other factors.

With continued reference to FIG. 15, the second component 304 is configured to provide multiple electrical pathways for conducting electricity through to the first component 302. In the illustrated embodiment, an outer electrical pathway 374 may extend from the raised rim 354, i.e., a first contact surface, toward the tapered stem 324. Also, an inner electrical pathway 376 extends from the central portion 350, i.e., a second contact surface, toward the tapered stem 324, with the central portion 350 being disposed concentrically with the raised rim 354, as best seen in FIG. 14. Accordingly, electricity conducted from the outer electrical pathway 374 and the inner electrical pathway 376 converge and/or combine within the electrical contact assembly 300 at a node 378 that may be located, in some examples, within the tapered stem 324. From the node 378, the electricity then travels in a third electrical pathway 380 through the mating surface 330 to the first component 302. In this way, electricity is conducted through the electrical contact assembly 300 according to multiple pathways. It is contemplated that greater or fewer electrical pathways may be provided, or that different materials may be provided to direct or control the flow of electricity through the electrical contact assembly 300. It is further contemplated that in some applications, the inner electrical pathway 376 may be a primary pathway and the outer electrical pathway 374 may be a secondary pathway.

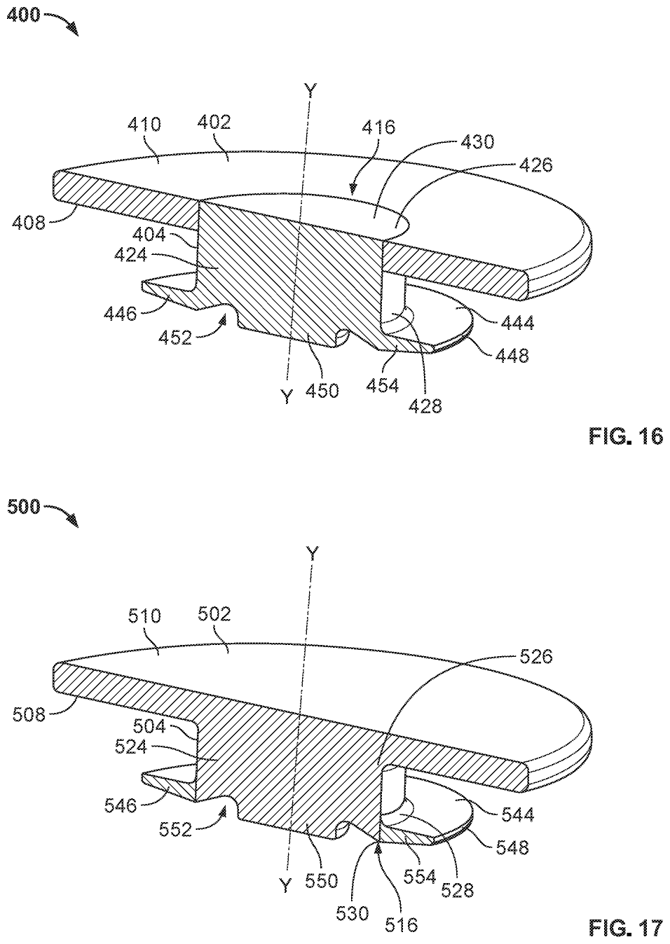

Referring to FIG. 16, another embodiment of an electrical contact assembly 400 is provided. In this embodiment, elements that are shared with—i.e., that are structurally and/or functionally identical to—elements present in the embodiment of electrical contact assembly 300 are represented by reference numeral increased by a value of 100. With reference to FIG. 16, the electrical contact assembly 400 includes a first component 402 and a second component 404 that, when assembled, are configured to be joined together in axial alignment about a central axis Y. The first component 402 is provided as an annular disc having a bottom surface 408 opposite a top surface 410 and a central aperture or hole 416 formed therethrough. The central aperture 416 is configured to receive a stem 424 of the second component 404. The stem 424 extends axially between a first end 426 and a second end 428. In the illustrated embodiment, the stem 424 is provided as a cylindrical extrusion of solid material, although other configurations are possible. The stem 424 defines a mating surface 430 that is configured to be mounted flush with the top surface 410 of the first component 402 when assembled, as illustrated in FIG. 16. Further, second component 404 includes a top surface 444 that is opposite a bottom surface 446, which together define an outer periphery 448 of the second component 404. The stem 424 is centrally disposed on the top surface 44 about the outer periphery 448. The bottom surface 446 includes a central raised portion 450 that is surrounded by an annular channel 452. The annular channel 452 is formed as a scalloped recess that is surrounded by an outer rim 454 that extends at an angle from the annular channel 452 radially outwardly to the outer periphery 448. Accordingly, the outer rim 454 extends obliquely relative to the central axis Y, while the planar surface defined by the central raised portion 450 is perpendicular to the central axis Y. Joining the first component 402 to the second component 404 involves axially aligning and inserting the stem 424 within the hole 416, such that the first and second components 402, 404 are concentric relative to one another about the central axis Y. It will be appreciated that the first and second component 402, 404 may be jointed using techniques described herein, such as, e.g., ultrasonic welding.

Referring to FIG. 16, another embodiment of an electrical contact assembly 400 is provided. In this embodiment, elements that are shared with—i.e., that are structurally and/or functionally identical to—elements present in the embodiment of electrical contact assembly 300 are represented by reference numeral increased by a value of 100. With reference to FIG. 16, the electrical contact assembly 400 includes a first component 402 and a second component 404 that, when assembled, are configured to be joined together in axial alignment about a central axis Y. The first component 402 is provided as an annular disc having a bottom surface 408 opposite a top surface 410 and a central aperture or hole 416 formed therethrough. The central aperture 416 is configured to receive a stem 424 of the second component 404. The stem 424 extends axially between a first end 426 and a second end 428. In the illustrated embodiment, the stem 424 is provided as a cylindrical extrusion of solid material, although other configurations are possible. The stem 424 defines a mating surface 430 that is configured to be mounted flush with the top surface 410 of the first component 402 when assembled, as illustrated in FIG. 16. Further, second component 404 includes a top surface 444 that is opposite a bottom surface 446, which together define an outer periphery 448 of the second component 404. The stem 424 is centrally disposed on the top surface 44 about the outer periphery 448. The bottom surface 446 includes a central raised portion 450 that is surrounded by an annular channel 452. The annular channel 452 is formed as a scalloped recess that is surrounded by an outer rim 454 that extends at an angle from the annular channel 452 radially outwardly to the outer periphery 448. Accordingly, the outer rim 454 extends obliquely relative to the central axis Y, while the planar surface defined by the central raised portion 450 is perpendicular to the central axis Y. Joining the first component 402 to the second component 404 involves axially aligning and inserting the stem 424 within the hole 416, such that the first and second components 402, 404 are concentric relative to one another about the central axis Y. It will be appreciated that the first and second component 402, 404 may be jointed using techniques described herein, such as, e.g., ultrasonic welding.

Referring to FIG. 17, another embodiment of an electrical contact assembly 500 is provided. In this embodiment, elements that are shared with—i.e., that are structurally and/or functionally identical to—elements present in the embodiment of electrical contact assembly 400 are represented by reference numeral increased by a value of 100. With reference to FIG. 17, the electrical contact assembly 500 includes a first component 502 and a second component 504 that, when assembled, are configured to be joined together in axial alignment about a central axis Y. In this embodiment, the first component 502 includes a disc-shaped bottom surface 508 that is opposite a top surface 510. The second component 504 is provided as an annular component having a central aperture 516 in which a stem 524 of the first component 502 is received. The stem 524 extends axially from the bottom surface 508 of the first component 502 as a cylindrical protrusion. In particular, the stem 524 extends from a first end 526 to a second end 528 that is configured to be mated with or joined with the second component 504. The second component 504 includes a top surface 544 opposite a bottom surface 546 and the central aperture 516. In this embodiment, the stem 524 of the first component 502 includes a mating surface or interface 530 that is configured to be received within the central aperture 516 of the second component 504 and to be flush with a portion of the bottom surface 546 thereof. The first component 502 includes a central raised portion 550 about which an annular channel 552 is formed as a scalloped recess extending radially between the central raised portion 550 and the mating surface 530. Accordingly, the annular channel 552 is circumjacent the central raised portion 550 on the stem 524, and the second component 504 is configured to surround the second end 528 of the stem 524 to be flush with the mating surface 530. As such, the electrical contact assembly 500 differs from the electrical contact assembly 400 in that the first component 502 carries the stem 524 that fits concentrically within central aperture 516 of the second component. Further, the central raised portion 550, the annular channel 552, and the mating surface 530 are carried by the first component 502. It will be appreciated that the first and second component 502, 504 may be joined using techniques described herein, such as, e.g., ultrasonic welding.

It is contemplated that the first components 102, 202, 302, 402, 502 and the second components 104, 204, 304, 404, 504 may be sized and shaped differently than shown. It will also be appreciated that the electrical contact assemblies 100, 200, 300, 400, 500 may be manufactured using a variety of methods. Further, it is contemplated that the electrical contact assemblies 100, 200, 300, 400, 500 may be comprised of any electrically conductive material, which may include aluminum, copper, or the like. Accordingly, each electrical contact assembly 100, 200, 300, 400, 500 may be composed of multiple materials, rather than a single material. For example, the first components 102, 202, 302, 402, 502 may be composed of a different material than the second components 104, 204, 304, 404, 504 to improve electrical conductivity, or to facilitate joining via a welding process, or to protect against corrosion, or to improve interaction or engagement with an enclosure. In this way, the electrical contact assemblies 100, 200, 300, 400, 500 provide greater potential for controlling electricity, for becoming joined or assembled together, for extending an operable lifespan, for preventing failure, and for becoming mounted to external structures. Optionally, the enclosure may comprise a non-conductive material or an electrically isolating material, which may include plastic or metal. Further, as another benefit of the two-piece construction of the electrical contact assemblies 100, 200, 300, 400, 500 the enclosure may be hermetically sealed or semi-hermetically sealed. It is also contemplated that the electrical contact assemblies 100, 200, 300, 400, 500 may be used in a variety of applications, including electric vehicles, industrial and manufacturing machines or devices, energy storage, and consumer goods.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the present disclosure and claims. The entire disclosure of each patent and publication cited herein is incorporated by reference, as if each such patent or publication were individually incorporated by reference herein.

1. An electrical contact assembly, comprising:
a first component including an upper side wall defining a mating cavity; and
a second component including a stem having a first end and a second end opposite the first end, wherein a flange extends from the second end and defines an electrical contact surface area, and wherein the first end defines a mating surface that is configured to be coupled to the first component within the mating cavity.

2. The electrical contact assembly of claim 1, wherein a bottom surface of the flange includes a channel and a central portion disposed concentrically along a central axis.

3. The electrical contact assembly of claim 1, wherein the first component and the second component together define at least two electrical pathways,
wherein a first pathway extends from a first contact area that is disposed concentrically about and spaced apart from a second contact area,
wherein a second pathway extends from the second contact area, and
wherein the first and second pathways converge within the electrical contact assembly.

4. The electrical contact assembly of claim 1, wherein the stem defines a draft angle between the first end and second end, and wherein the stem is configured to abut an inner side wall within the mating cavity.

5. The electrical contact assembly of claim 2, wherein a diameter of the channel is larger than a diameter of the stem.

6. The electrical contact assembly of claim 5, wherein the second component includes an upper rim that defines a diameter that is greater than the diameter of the stem.

7. The electrical contact assembly of claim 6, wherein the upper rim of the second component is configured to abut a contact surface of the upper side wall.

8. An electrical contact assembly, comprising:
a first component including a first electrical contact surface; and
a second component including a stem, and a flange extending radially outward from the stem, the stem defining a second electrical contact surface,
wherein the second electrical contact surface includes a plurality of protrusions.

9. The electrical contact assembly of claim 8, wherein the plurality of protrusions are provided in a unit density of one protrusion per square millimeter along the second electrical contact surface.

10. The electrical contact assembly of claim 8, wherein the first component having a first surface area, the second component having a second surface area, wherein the second component is configured to be permanently coupled to the first component, wherein the second component includes a third surface area and a fourth surface area, the third surface area being less or greater than the second surface area, wherein a sum of the third surface area and the fourth surface area is greater than or equal to the second surface area, and wherein the second, third, and fourth surface areas are spaced apart from one another.

11. The electrical contact assembly of claim 8, wherein the first component and the second component are coupled along the first and second electrical contact surfaces, the second component establishing at least two electrical pathways toward the first component, wherein a first pathway extends from a first contact area that is disposed concentrically about and spaced apart from a second contact area, wherein a second pathway extends from the second contact area, and wherein the first and second pathways converge within the two-piece assembly.

12. The electrical contact assembly of claim 8, wherein the first component is configured to be coupled to the second component, wherein electricity is configured to be passed through the first component to the second component, wherein the electrical contact assembly is configured to be mounted to an enclosure, and wherein a hermetic seal is formed by the electrical contact assembly to at least partially prevent ingress or egress relative to the enclosure.

13. The electrical contact assembly of claim 8, wherein the second electrical contact surface of the stem is disposed concentrically with the first electrical contact surface of the first component.

14. An electrical contact assembly, comprising:
a first component including a first electrical contact surface, the first component defined by a first length and a first width; and
a second component including a stem, and a flange extending outwardly from the stem, the stem defining a second electrical contact surface,
wherein the second electrical contact surface includes a plurality of protrusions.

15. The electrical contact assembly of claim 14, wherein the second component further comprises a central portion and a rim disposed opposite the stem, the central portion and the rim establishing an electrical pathway between the first and second electrical contact surface.

16. The electrical contact assembly of claim 14, wherein the first length and the first width define a shape of the first component, and a shape of the second component is identical to the shape of the first component.

17. The electrical contact assembly of claim 16, wherein a shape of the stem is identical to the shape of the first component and second component.

18. The electrical contact assembly of claim 16, wherein a size of the second component is smaller than a size of the first component.

19. The electrical contact assembly of claim 14, wherein the first component and the second component are coupled along the first and second electrical contact surfaces, the second component establishing at least two electrical pathways toward the first component, wherein a first pathway extends from a first contact area that is disposed concentrically about and spaced apart from a second contact area, wherein a second pathway extends from the second contact area, and wherein the first and second pathways converge within the electrical contact assembly.

20. The electrical contact assembly of claim 14, wherein the first component is axially aligned with the second component.
